(19) United States
(12) Patent Application Publication
(10) Pub. No.: US 2026/0133374 A1
(43) Pub. Date: May 14, 2026

(54) Secure Pin Clamp for MPO Fiber Optic Connectors

(71) Applicant: US Conec Ltd., Hickory, NC (US)

(72) Inventors: Jason Higley, Hickory, NC (US); Darrell R. Childers, Hickory, NC (US)

(21) Appl. No.: 19/032,312

(22) Filed: Jan. 20, 2025

Related U.S. Application Data
(60) Provisional application No. 63/622,155, filed on Jan. 18, 2024.

(51) Int. Cl. G02B 6/38

(52) U.S. Cl. CPC G02B 6/3882

(57) ABSTRACT

A pin claim has a forward pin clamp portion having two flexible members extending rearwardly therefrom on opposite lateral sides of an opening of the forward pin clamp portion, and a rearward pin clamp portion movably engaged to the forward pin clamp portion and configured to engage the spring when assembled in the fiber optic connector. The rearward pin clamp portion has two recesses to respectively receive the two flexible members from the forward pin clamp portion, wherein each of the two flexible members is movable between a first position and a second position within each of the two recesses, and wherein the forward pin clamp portion and the rearward pin clamp portion are inseparable from one another.

### REFERENCE TO RELATED CASES

This application claims priority under 35 U.S.C. § 119(e) to U.S. provisional application no. 63/622,155 filed on Jan. 18, 2024, the contents of which are hereby incorporated by reference in their entirety.

### BACKGROUND OF THE INVENTION

Fiber optic connector components for multi-fiber MPO connectors, like the MTP® Pro brand fiber optic connectors provided by the Applicant, are shipped as a bag of parts to cable assembly houses that then assemble the components with optical fibers to result in the final connector. A male MPO fiber optic connector has guide pins held by an MT ferrule. A pin clamp may be provided rearward of the MT ferrule. These guide pins are removable to change a gender of the MPO connector from male to female or vice-versa, as needed. When a guide pin is present, i.e., for a male MPO connector, the pin clamp securely holds the guide pins. The pin clamp may also be called a guide pin keeper. One such conventional pin clamp is described in U.S. Pat. No. 11,327,249 owned by the Applicant (hereinafter “the '249 patent,” Atty. Dkt. No. USCO-070-02), the contents of which are incorporated herein by reference in their entirety.

In the MTP® Pro connectors, the pin clamp is typically a three-piece structure with a front piece or a forward pin clamp portion, a back piece or a rearward pin clamp portion, and a guide pin retaining plate held therebetween. FIG. 1, reproduced from FIG. 7 of the aforementioned '249 patent shows symmetric shaped holding area for the two guide pins on the retaining plate. That is, the retaining plate can go in between the forward and the rearward clamp portions in two identical ways—one flipped about the width from the other. FIG. 2 shows the conventional pin clamp assembled together with the guide pins (MT ferrule removed for a clearer view), with the retaining plate sandwiched between the front piece and the back piece of the pin clamp. As is also known, a spring inside the MPO connector engages a rear surface of the rearward pin clamp portion (or, the back piece) and applies a longitudinal force to the pin clamp (i.e., a force in the mating direction).

Applicant has found that during shipping some unexpected problems may occur with the pin clamp. Typically, the pin clamp is said to be in a locked position when the guide pins are securely held. The forward pin clamp portion and the rearward pin clamp portion may move relative to each other and be disoriented, which may allow the guide pins to come off the pin clamp (e.g., during shipping or assembly of the pin clamp into the MPO connector). See FIG. 12 of the '249 patent. A tool is then used during a gender change operation to intentionally act upon the pin clamp so that the pin clamp moves to an unlocked position. See FIG. 13 of the '249 patent. However, during shipping, when no spring forces are present on the pin clamp (which is outside the MPO connector during shipping), the forward pin clamp portion and the rearward pin clamp portion can move relative to each other unintentionally and move to the unlocked position, which also results in the pins to become loose during shipping or even during connectorization (when the pin clamp is being assembled into the MPO connector).

Further, the inventors have identified that it is possible with the conventional design that even while inside a terminated MPO connector and after the pin clamp has intentionally been moved to an unlocked position, friction between the forward pin clamp portion and the rearward pin clamp portion will prevent the pin clamp from moving to a fully locked position. This poses a problem for a future use of the pin clamp.

Additionally, in the field when the two MPO connectors are mated, the guide pins may come off, i.e., the retaining plate may not engage the correct location of the guide pin slot in the guide pin, and so one would get pin transfer during mating later on.

### SUMMARY OF THE INVENTION

The present invention is directed to a pin clamp for use with a fiber optic connector, the fiber optic connector having at least one housing, a fiber optic ferrule disposed at least partially within the at least one housing of the fiber optic connector, the fiber optic ferrule having guide pin openings extending from a front face to a rear face of the fiber optic ferrule to receive a guide pin therein, a spring, and a spring push, the pin clamp that includes a forward pin clamp portion to engage the rear face of the fiber optic ferrule, the forward pin clamp portion having two flexible members extending rearwardly therefrom on opposite lateral sides of an opening of the forward pin clamp portion, and a rearward pin clamp portion movably engaged to the forward pin clamp portion and configured to engage the spring when assembled in the fiber optic connector, the rearward pin clamp portion having two recesses to respectively receive the two flexible members from the forward pin clamp portion, wherein each of the two flexible members is movable between a first position and a second position within each of the two recesses, and wherein the forward pin clamp portion and the rearward pin clamp portion are inseparable from one another.

In some embodiments, the forward pin clamp portion and the rearward pin clamp portion are movable relative to one another between a third position in which a guide pin is engaged by the pin clamp and a fourth position in which the guide pin is disengaged from the pin clamp and wherein the spring biases the pin clamp into the third position.

In some embodiments, the pin clamp further includes a first latch on a top side of the forward pin clamp portion configured to engage a first latch receiving recess on the rearward pin clamp portion, and a second latch on a bottom side of the forward pin clamp portion configured to engage a second latch receiving recess on the rearward pin clamp portion, wherein the first latch, the second latch, the first latch receiving recess and the second latch receiving recess each have an angled surface to prevent separation of the forward pin clamp portion from the rearward pin clamp portion.

In some embodiments, the two recesses have a closed end and an open end forward of the closed end, the open end having a dimension larger than the closed end.

In other embodiments, the pin clamp further includes a lead-in surface surrounding the opening of the forward pin clamp portion.

In some embodiments, the two flexible members are offset from each other along a height of the forward pin clamp portion.

In other embodiments, the pin clamp is in a bag of parts.

In one embodiment, the pin clamp further includes a guide pin retaining plate configured for positioning between the forward pin clamp portion and the rearward pin clamp portion.

In one embodiment, the guide pin retaining plate includes a first holding area for a first guide pin and a second holding area for a second guide pin, the first holding area having a geometry different from the second holding area.

In another aspect, the invention is directed to a fiber optic connector having removable guide pins that includes at least one housing defining a passageway, a fiber optic ferrule disposed at least partially within the passageway of the at least one housing of the fiber optic connector, the fiber optic ferrule having guide pin openings extending through the fiber optic ferrule from a front face to a rear face thereof to receive a guide pin therein, a pin clamp having a forward pin clamp portion to engage the rear face of the fiber optic ferrule, the forward pin clamp portion having guide pin openings therethrough to receive the guide pin and two flexible members extending rearwardly therefrom on opposite lateral sides of an opening of the forward pin clamp portion, and a rearward pin clamp portion positioned rearward of the forward pin clamp portion and configured to engage a spring of the fiber optic connector disposed within the at least one housing and rearwardly of the rearward pin clamp portion of the pin clamp and having two recesses to respectively receive the two flexible members from the forward pin clamp portion and each of the two flexible members is movable between a first position and a second position within each of the two recesses.

In one embodiment, there also is a spring push engaging the spring and the at least one housing to retain the spring and fiber optic ferrule with the at least one housing.

In one embodiment, the forward pin clamp portion and the rearward pin clamp portion are movable relative to one another between a third position in which a guide pin is engaged by the pin clamp and a fourth position in which the guide pin is disengaged from the pin clamp and wherein the spring biases the pin clamp into the third position.

In one embodiment, the pin clamp also includes a first latch on a top side of the forward pin clamp portion configured to engage a first latch receiving recess on the rearward pin clamp portion, and a second latch on a bottom side of the forward pin clamp portion configured to engage a second latch receiving recess on the rearward pin clamp portion, wherein the first latch, the second latch, the first latch receiving recess and the second latch receiving recess each have an angled surface to prevent separation of the forward pin clamp portion from the rearward pin clamp portion.

In one embodiment, the two recesses have a closed end and an open end forward of the closed end, the open end having a dimension larger than the closed end.

In one embodiment, the forward pin clamp portion further comprises a lead-in surface surrounding the opening of the forward pin clamp portion.

In one embodiment, the two flexible members are offset from each other along a height of the forward pin clamp portion.

In one embodiment, the pin clamp further includes a guide pin retaining plate configured for positioning between the forward pin clamp portion and the rearward pin clamp portion.

In one embodiment, the guide pin retaining plate includes a first holding area for a first guide pin and a second holding area for a second guide pin, the first holding area having a geometry different from the second holding area.

In one embodiment, the forward pin clamp portion further comprises at least one forward extending projection to engage a recess in a rear end of the fiber optic ferrule.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description of the present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 illustrates a prior art fiber optic ferrule with a three piece pin keeper;

FIG. 2 shows the conventional pin clamp of FIG. 1 assembled together with the guide pins (MT ferrule removed for a clearer view);

FIG. 3 illustrates one embodiment of a three piece pin keeper or pin clamp (with the MT ferrule removed) according to the present invention;

FIG. 4 is a rear perspective view of the forward pin clamp portion of the pin clamp in FIG. 3;

FIG. 5 is a front perspective view of the forward pin clamp portion of the pin clamp; in FIG. 3;

FIG. 6 is a top view of a cross section of the forward pin clamp in along the line 6-6 in FIG. 7;

FIG. 7 is a plan view of the forward pin clamp from the bottom thereof;

FIG. 8 is right side elevational view of one embodiment of a rearward pin clamp portion according to the present invention;

FIG. 9 is a perspective view of the rearward pin clamp portion in FIG. 8 from the front right side;

FIG. 10 is an elevational view of the pin keeper in FIG. 3 from the right side;

FIG. 11 is an elevational view of the pin keeper in FIG. 3 from the right side showing the engagement of the forward pin clamp portion with the rearward pin clamp portion;

FIG. 12 is an elevational view of the pin keeper in FIG. 3 from the left side showing the engagement of the forward pin clamp portion with the rearward pin clamp portion;

FIG. 13 is a right side view of a cross section of the pin keeper in FIG. 3;

FIG. 14 is a rear view of the pin keeper in FIG. 3 where the forward pin clamp portion and the rearward pin clamp portion have rotated relative to one another;

FIG. 15 is a perspective view of an embodiment of a guide pin retaining plate configured for positioning between the forward pin clamp portion and the rearward pin clamp portion according to the present invention;

FIG. 16 is a front elevational view of the pin keeper in FIG. 3 in a locked position; and

FIG. 17 is a front elevational view of the pin keeper in FIG. 3 in an unlocked position.

### DETAILED DESCRIPTION OF THE PREFERRED EMBODIMENTS

Reference will now be made in detail to the present preferred embodiment(s) of the invention, examples of which are illustrated in the accompanying drawings. Whenever possible, the same reference numerals will be used throughout the drawings to refer to the same or like parts.

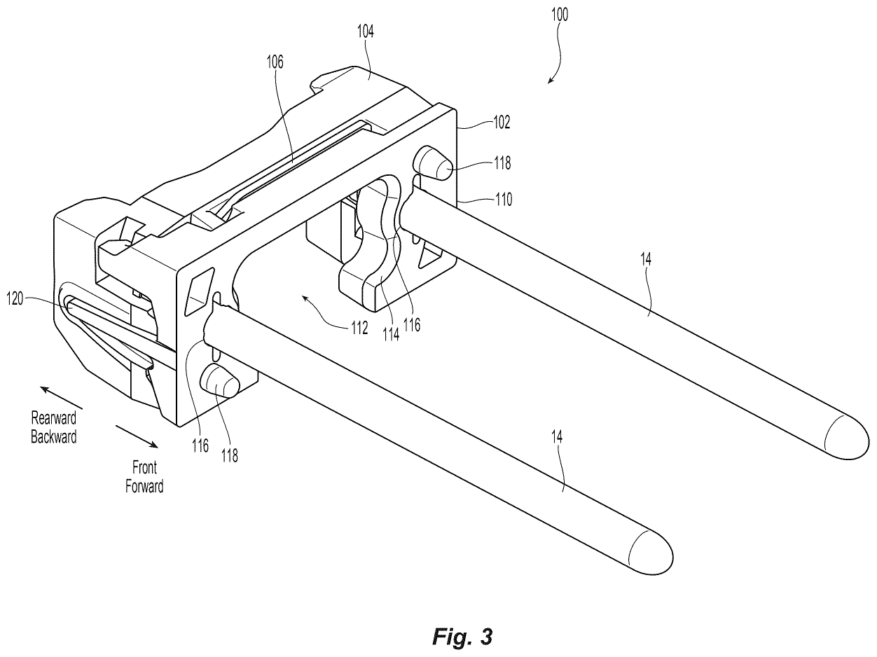

Applicant notes that the term “front” or “forward” means that direction where the fiber optic connector would meet with another fiber optic connector or device, while the term “backward” or “rearward” is used to mean the direction from which the optical fibers enter into the fiber-optic ferrule or fiber optic connector. Each of the components will therefore have a front and rear, and the two respective fronts or forward portions of opposing ferrules would engage one another. Thus, in FIG. 3, the “front” of the pin keeper is on the right side and “forward” is to the right and out the page. “Rearward” or “rear” is that part of the pin keeper that is on the left side of the page and “rearward” and “backward” is toward the left and into the page.

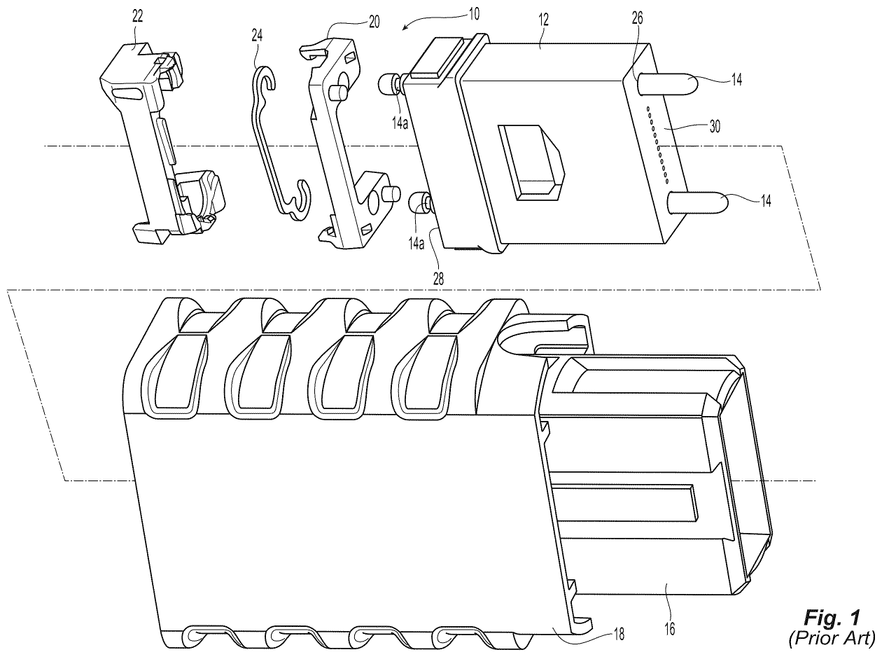

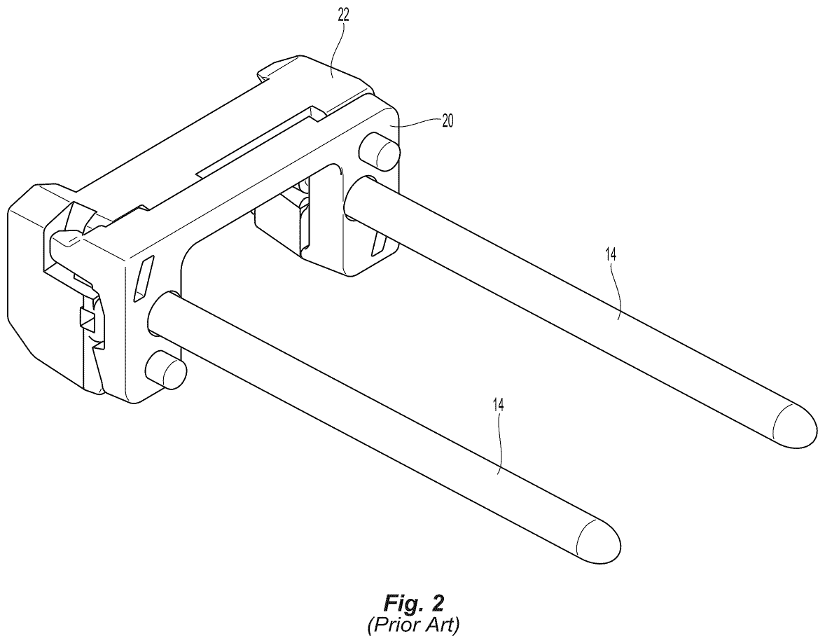

A prior art version of a three piece pin keeper 10 with a ferrule 12, guide pins 14, an inner housing 16, and an outer housing 18 is illustrated in FIGS. 1 and 2. The pin keeper 10 has a forward pin clamp portion 20, a rearward pin clamp portion 22, and a guide pin retaining plate 24 (not visible in FIG. 2). The housings 16,18 may also be used with the present invention. There may be other components within the housings 16,18, such as a spring push and a spring to bias the ferrule 12 forward in the housings 16,18. See, e.g., U.S. Pat. No. 11,327,249. The ferrule 14 has guide pin openings 26 to receive the guide pins 14 that extend between a rear face 28 and a front face 30 of the ferrule 14.

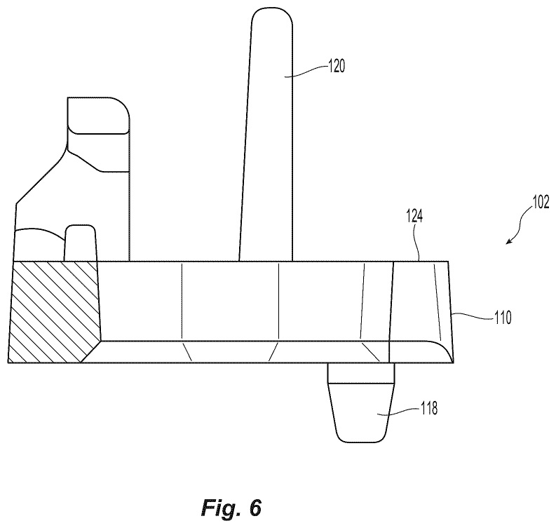

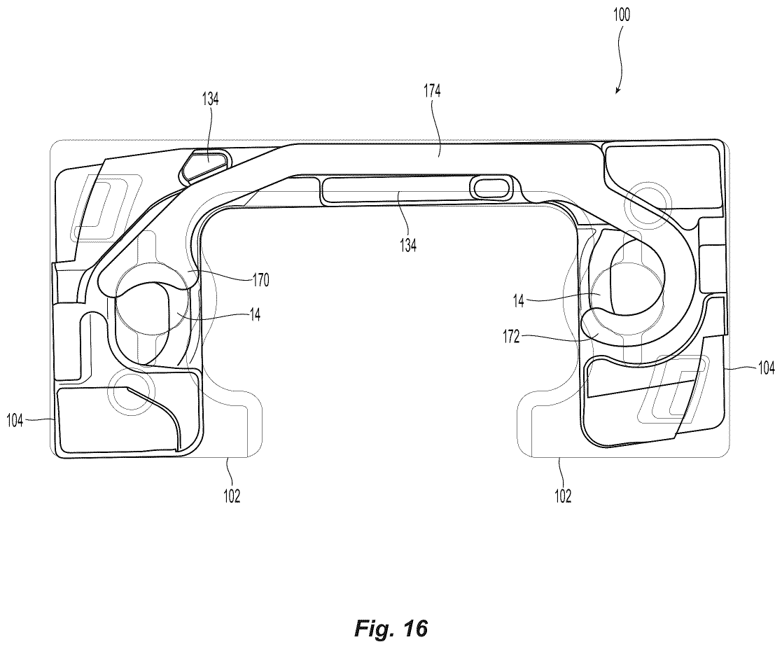

One embodiment of a pin keeper or pin clamp 100 according to the present invention is illustrated in FIGS. 3-17. As with the prior art pin keeper 10, there is a forward pin clamp portion 102, a rearward pin clamp portion 104, and a guide pin retaining plate 106. See FIGS. 16-18. As with the pin keeper 10, there may also be a number of other parts that make up a fiber optic connector. For example, there would be a spring push, a spring, and a crimp body that are shown and described in the '249 patent. There may also be an inner housing 16 and/or an outer housing 18, or at least one housing. See FIG. 1. The housings 16,18 may take on a different configuration than that shown here and still fall within the scope of the present invention.

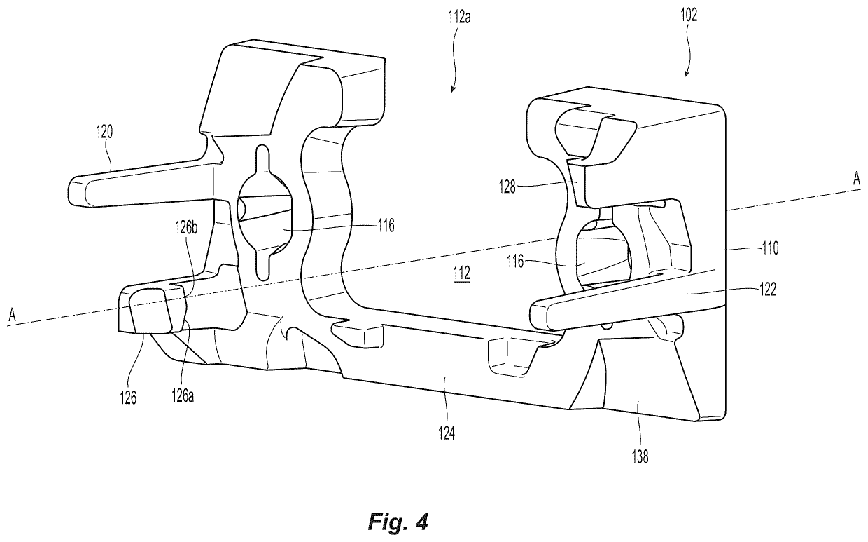

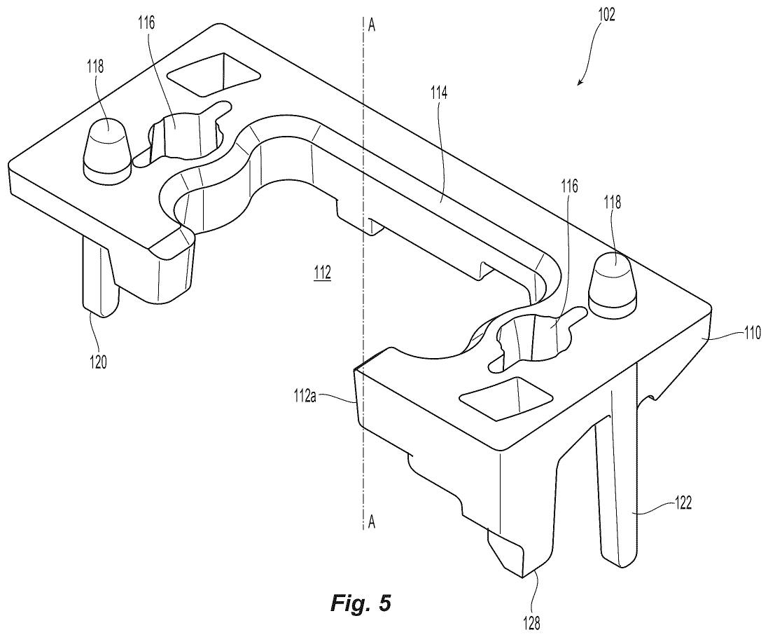

The forward pin clamp portion 102 is best illustrated in FIGS. 4-7. The forward pin clamp portion 102 has a main body 110 that forms an opening 112 to receive optical fibers (not shown). There is also a break 112a in the main body 110 to allow for access to the opening 112 in a different direction for positioning the optical fibers. The opening 112 could be on the top of the forward pin clamp portion 102 or it could be on the bottom thereof. Preferably, the opening 112 has a lead-in or a chamfer 114 (see, e.g., FIG. 5) that is provided to allow a smoother insertion of an optical fiber ribbon and a ferrule boot (not shown), or alternatively, loose optical fibers, between the sides of the pin clamp and subsequently into the ferrule 14. This lead-in 114 reduces the chances of the ferrule boot from snagging at the pin clamp and getting damaged, as the ferrule boot passes through the opening 112 for termination inside the ferrule 14. The lead-in 114 may be provided all around an opening through the forward pin clamp 102.

The forward pin clamp portion 102 also has a number of other structures that are relevant to its functionality. For example, the forward pin clamp portion 102 has guide pin openings 116 to receive an end of the guide pins 14 when installed. The guide pin openings 116 are disposed on opposite sides of the opening 112. The forward pin clamp portion 102 may also have engagement projections 118 that mate with corresponding openings in a rearward portion of the ferrule 12 to keep the ferrule 12 and the forward pin clamp portion 102 from moving relative to one another. Alternatively, the engagement projections 118 maybe on the ferrule 14 rather than the forward pin clamp portion 102.

Now turning to the rear side of the forward pin clamp 102, there are a number of other structures. First, on opposing sides of the opening 112 are two flexible members 120,122 that extend rearwardly and away from the main body 110 (and also beyond the rear face 124 of the forward pin clamp portion 102) and along a longitudinal axis A. The two flexible members 120,122 are also offset from one another in a vertical direction. That is, in FIG. 4, one of the two flexible members 120 (on the left side of the page) is closer to the break 112a in the main body 110 and may be above the longitudinal axis A, while the second one of the two flexible members 122 is farther from the break 112a and may be below the longitudinal axis A. Other relative asymmetric positions of the two flexible members 120,122 may be implemented, e.g., both on the same side of the longitudinal axis A but still vertically offset to each other. It will be appreciated by one of ordinary skill in the art that the positions of the two flexible members 120,122 may be switched between the forward pin clamp portion 102 and the rearward pin clamp portion 104. That is, the two flexible members 120,122 may be present on the rearward pin clamp portion 104 instead, but extending in the forward direction. In that scenario, the forward pin clamp portion 104 will instead have the recesses 140,142 to receive the two flexible members 120,122.

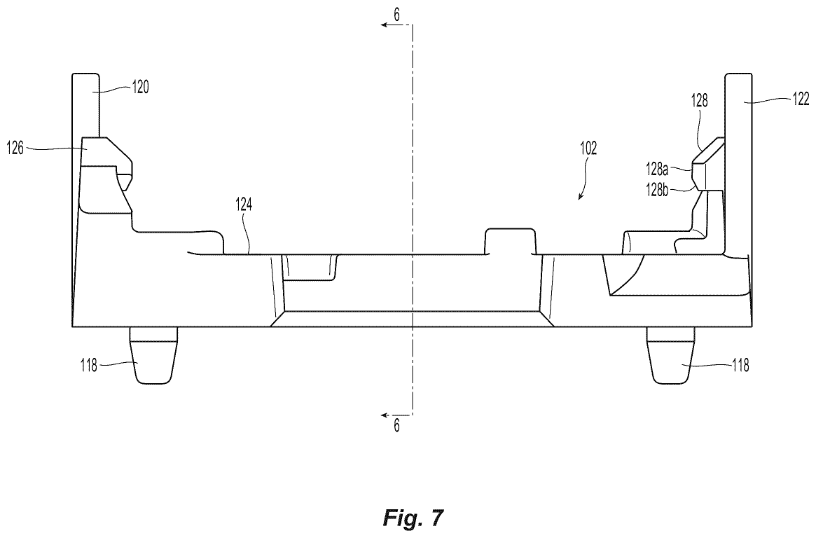

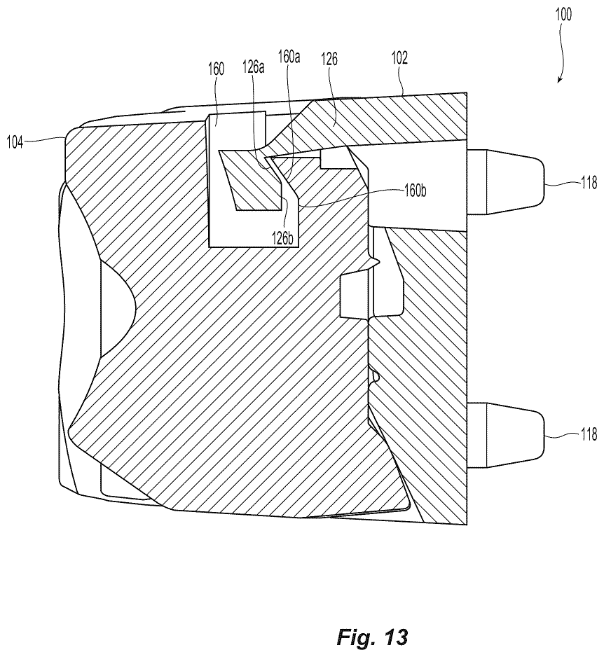

Next, there are latches 126,128 that are also on opposing sides of the opening 112. One of the latches (latch 128) is closer to the break 112a than the other (latch 126). Diagonally about the opening 112, the separation between the latch 126 and the latch 128 is more than a separation between the flexible member 120 and the flexible member 122. See FIG. 4. The latches 126,128 have engagement surfaces 126a,126b and 128a,128b to engage corresponding surfaces on the rearward pin clamp portion 104. See FIGS. 4 and 13. The engagement surface 126a is angled relative to the longitudinal axis A and the engagement surface 126b is straight and perpendicular thereto. The other side of the forward pin clamp portion 102 also has two engagement surfaces 128a,128b that are similar to engagement surfaces 126a,126b. The combination of the two engagement surfaces 126a,126b and 128a,128b along with other features of the rearward pin clamp portion 104 prevent the unexpected movement of the forward pin clamp portion 102 from the rearward pin clamp portion 104. See also FIG. 7. As such, the forward pin clamp portion 102 and the rearward pin clamp portion 104 stay together and are not separable, e.g., during shipping in a bag of parts.

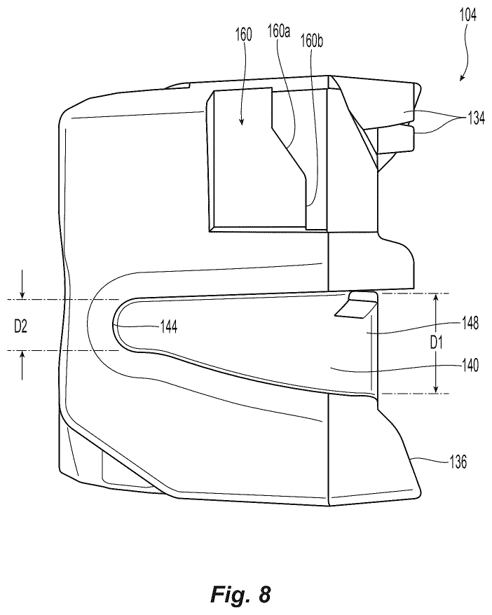

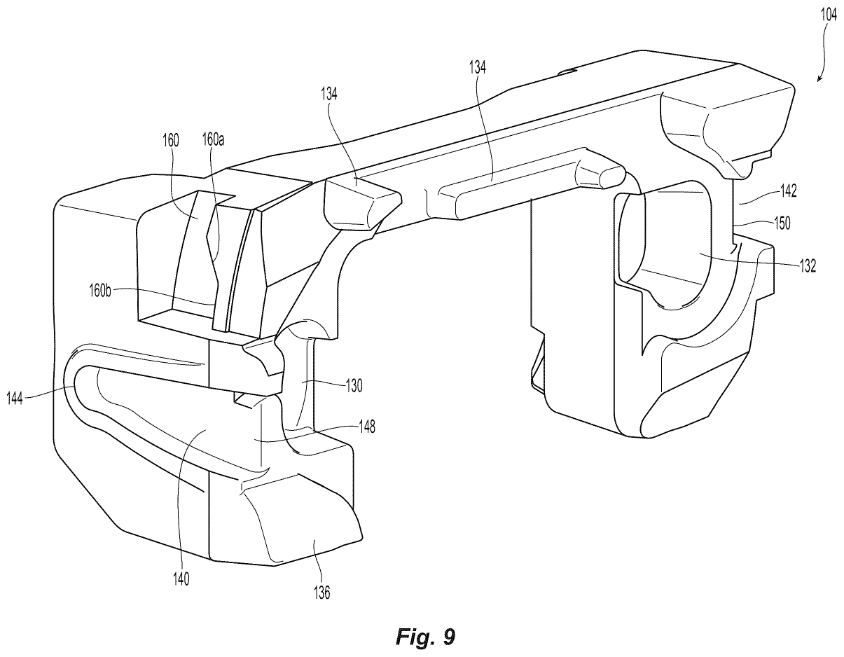

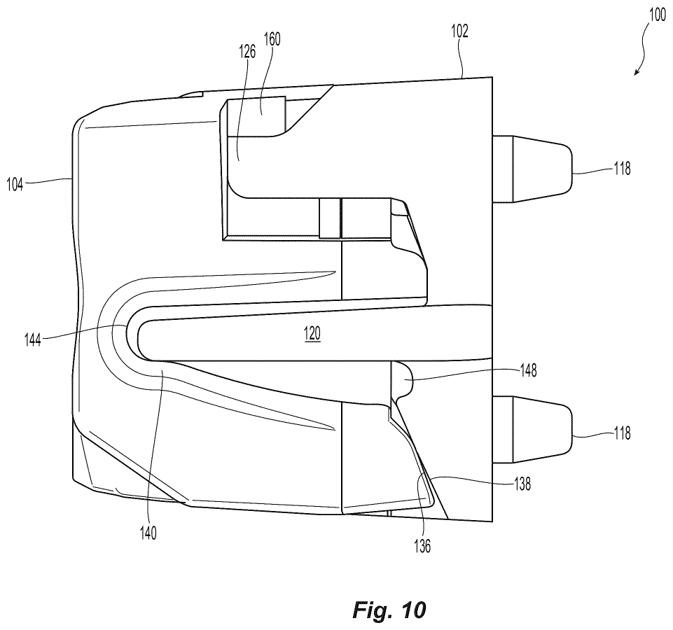

Turning now to FIGS. 8-15, the rearward pin clamp portion 104 will be discussed. The rearward pin clamp portion 104 is movably engaged to the forward pin clamp portion 102 and configured to engage the spring when assembled in the fiber optic connector (see FIG. 1 of the '249 patent). The rearward pin clamp portion 104 also has other elements that are common with the prior art version. For example, the rearward pin clamp portion 104 has receptacles 130,132 to receive ends of the guide pins 14. There are also supports 134 for the guide pin retaining plate 106 as will be discussed in more detail below. There is also a ramp 136 that engages with a ramp receiver 138 on the forward pin clamp portion 102 to assist with the alignment of forward pin clamp portion 102 and the rearward pin clamp portion 104. See FIGS. 9 and 10.

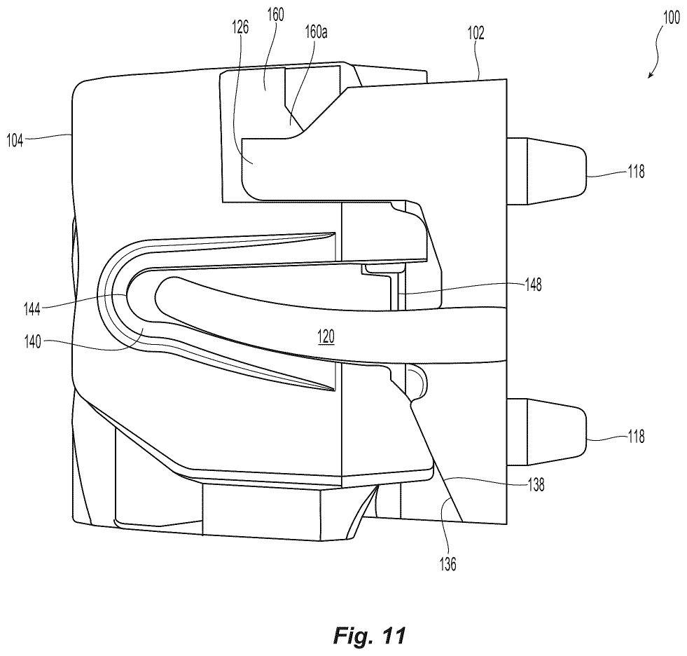

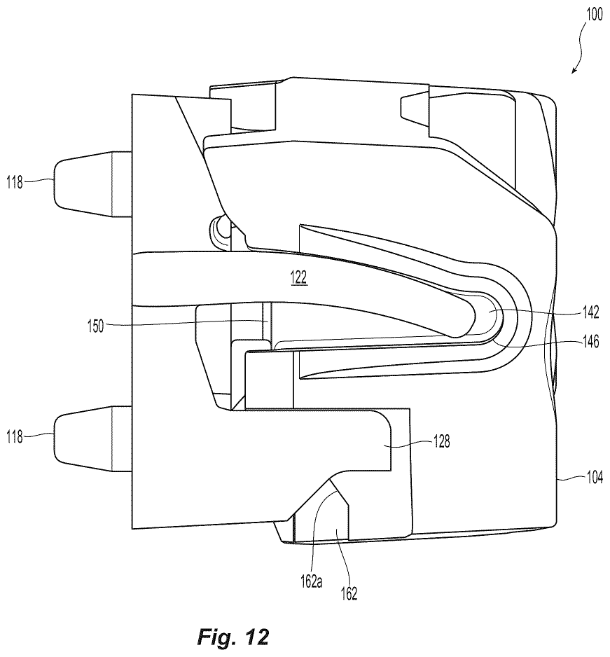

The rearward pin clamp portion 104 has two recesses 140,142 to respectively receive the two flexible members 120,122 from the forward pin clamp portion 102. The recesses have a closed end 144,146 and an open end 148,150 forward of the closed end 144,146, the open end 148,150 having a dimension D1 larger than a dimension D2 at the closed end 144,146. The open end 148,150 are to receive the two flexible members 120,122 from the forward pin clamp portion 102. See FIGS. 10-12. Considering FIGS. 10 and 11, one can see that the flexible member 120 is in a first position relative to the recess 140 in FIG. 10 and then the flexible member 120 is in a second, tensioned position in FIG. 11. The same two positions would occur on the other side of the rearward pin clamp portion 104 with flexible member 120 and recess 142 as illustrated in FIG. 12. Such tensioned and relaxed positions of the flexible members 120,122 allows reducing the stresses on the assembled pin clamp 100 inside the bag of parts during shipping, and thus reduces the chances of the forward pin clamp portion 102 and the rearward pin clamp portion 104 from disassembling from each other. It should be noted that with the forward pin clamp portion 102 is engaged with the ferrule 12 through the engagement projections 118 and the rearward pin clamp portion 104 is biased forward toward the ferrule 12 with the spring when connectorized. As such, the forward pin clamp portion 102 and the rearward pin clamp portion 104 are inseparable from one another whether after connectorization or before (e.g., during shipping inside the bag of parts). However, the rearward pin clamp portion 104 can move relative to the forward pin clamp portion 102 and the ferrule 12 without being separated along the longitudinal axis A, or in any other direction for that matter. Such movement between the forward pin clamp portion 102 and the rearward pin clamp portion 104 is rotational. The relaxed state of the two flexible members 120,122 is a locked state of the pin clamp 100 in which the forward pin clamp portion 102 and the rearward pin clamp portion 104 hold the guide pins securely, whereas the tensions state of the two flexible members 120,122 is an unlocked state of the pin clamp 100 in which the forward pin clamp portion 102 and the rearward pin clamp portion 104 release the guide pins. It is in the tensioned state that the forward pin clamp portion 102 and the rearward pin clamp portion 104 are rotated relative to each other and are not rotationally aligned.

The rearward pin clamp portion 104 also has two latch receiving recesses 160,162 to receive the latches 126,128, respectively. The latch receiving recess 160 is visible in FIGS. 8-11 and 13, while latch receiving recess 162 is visible in FIG. 12. The latch receiving recess 160 is on the upper right side of the rearward pin clamp portion 104 and the latch receiving recess 162 is on the lower left side thereof. Each of the latch receiving recesses 160,162 have cooperating features for the latches 126,128. That is, the two latch receiving recesses 160,162 have engagement surfaces 160a,160b and 162a,162b, respectively, to engage corresponding surfaces on the forward pin clamp portion 102-126a,126b and 128a, 128b. See FIGS. 8, 9, and 13. As shown, the engagement surfaces 160a and 160b are at an angle relative to each other, in contrast with the conventional pin keeper 22 shown in FIG. 1 where these two surfaces are one and the same straight surface. Further, the engagement surfaces 160a, 160b will aid in preventing longitudinal separation of the forward pin clamp potion 102 from the rearward pin clamp portion 104.

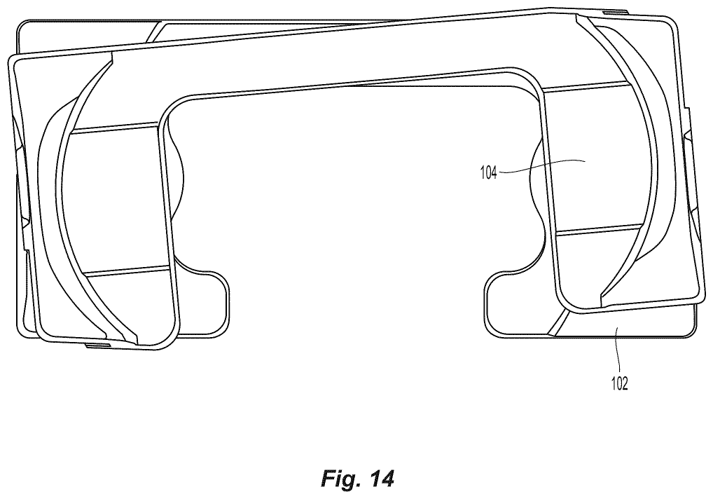

The combination of the two flexible members and corresponding recesses, along with the latches and latch receiving recesses keeps the front and rearward pin clamp portions 102,104 from moving relative to one another unexpectedly or unintentionally, e.g., during forces experienced during shipping inside the bag of parts or a kit. Thus, as shown in FIG. 14, the two pin clamp portions 102,104 will not move relative to one another unless actively manipulated by a user. FIG. 14 shows the rearward pin clamp portion 104 rotated relative to the forward pin clamp portion 102.

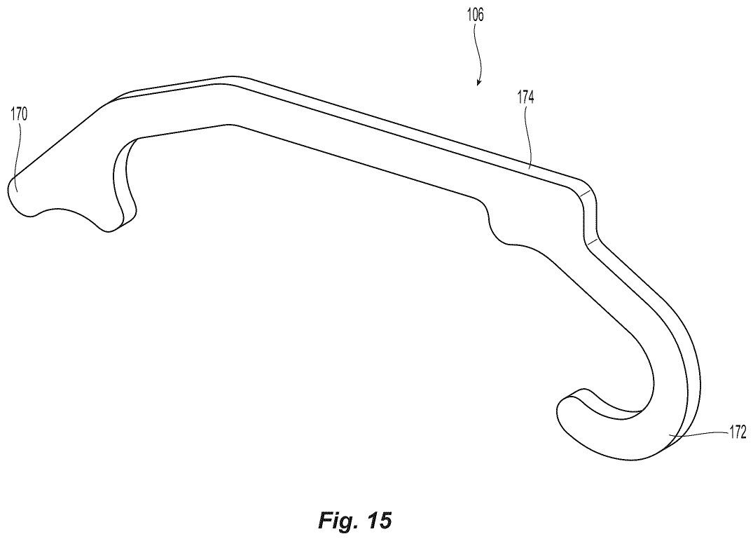

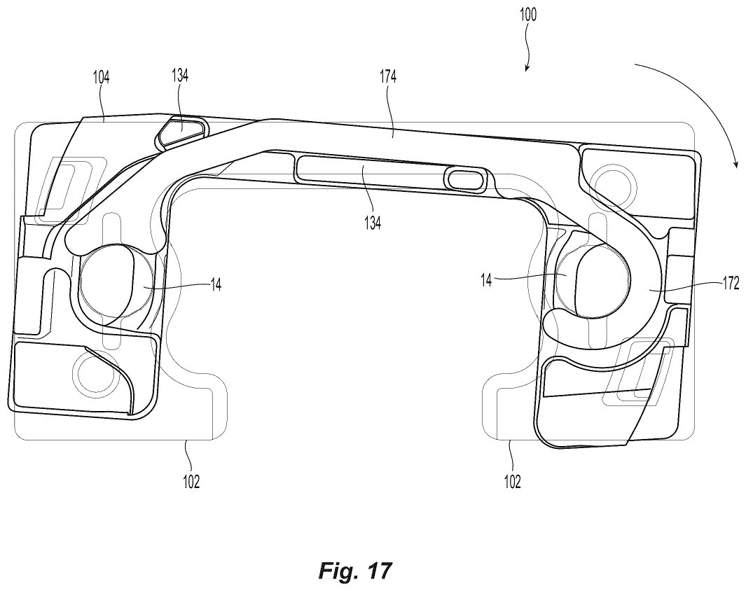

For completeness, FIGS. 15-17 show the presence of the guide pin retaining plate 106 and its interaction with the forward pin clamp portion 102, rearward pin clamp portion 104, and guide pins 14. FIG. 15 illustrates one embodiment of a guide pin retaining plate 106 that is positioned between the forward pin clamp portion 102 and the rearward pin clamp portion 104. The guide pin retaining plate 106 has ends with partially circular portions 170 and 172 joined by an elongated member 174. The elongated member 174 matches up with and is acted upon by the supports 134. Each of partially circular portions 170 and 172 match a reduced diameter of each of the guide pins 14, so that the portions 170 and 172 are able to pass into those reduced portions 14a. The first circular portion 170 is a smaller portion of a circle than the second circular portion 172. In this respect, the guide pin retaining plate 106 has an asymmetric structure along a lateral direction (i.e., along a width thereof). FIGS. 16 and 17 show the pin keeper 100 in a locked position and in an unlocked position, respectively, from the front and towards the rear of the pin keeper 100. The forward pin clamp portion 102 is illustrated in a lighter line than the guide pin retaining plate 106 and the rearward pin clamp portion 104 so that the relative movements can be seen. In FIG. 16, portions 170 and 172 of the guide pin retaining plate 106 are disposed within reduced portions 14a of the guide pins 14. This prevents the guide pins 14 from being removed from the pin keeper 100 or installed if there are no guide pins 14 already loaded. In FIG. 17, the rearward pin clamp portion 104 has been rotated clockwise (indicated by the arrow) by an adequate force by a user (and not from regular movements and usage), and it is clear that the portions 170 and 172 of the guide pin retaining plate 106 are removed from the reduced portions 14a of the guide pins 14. The entirety of the portions 170 and 172 of the guide pin retaining plate 106 are visible, meaning that they have been removed from the reduced portions 14a. Now the guide pins 14 can be removed (or added if none have been previously installed).

Applicant also notes that some or all of the components of the pin keeper 100 (and the housings and other components) discussed above could be included in what is known as a bag-of-parts, which is what is shipped to cable assembly houses for connectorization of these components. A bag-of-parts is generally those items needed to complete a specific combination. In this case, the bag-of-parts would be used with optical fibers (or other parts such as a strain relief boot, etc.) provided from somewhere else to complete a fiber optic connector with removable guide pins. Thus, the present invention addresses the issue of accidental separation of the components during shipping.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed:

1. A pin clamp for use with a fiber optic connector, the fiber optic connector having at least one housing, a fiber optic ferrule disposed at least partially within the at least one housing of the fiber optic connector, the fiber optic ferrule having guide pin openings extending from a front face to a rear face of the fiber optic ferrule to receive a guide pin therein, a spring, and a spring push, the pin clamp comprising:
a forward pin clamp portion to engage the rear face of the fiber optic ferrule, the forward pin clamp portion having two flexible members extending rearwardly therefrom on opposite lateral sides of an opening of the forward pin clamp portion; and
a rearward pin clamp portion movably engaged to the forward pin clamp portion and configured to engage the spring when assembled in the fiber optic connector, the rearward pin clamp portion having two recesses to respectively receive the two flexible members from the forward pin clamp portion,
wherein each of the two flexible members is movable between a first position and a second position within each of the two recesses, and
wherein the forward pin clamp portion and the rearward pin clamp portion are also movable relative to one another without being separable from one another.

2. The pin clamp of claim 1, wherein the forward pin clamp portion and the rearward pin clamp portion are movable relative to one another between a third position in which a guide pin is engaged by the pin clamp and a fourth position in which the guide pin is disengaged from the pin clamp and wherein the spring biases the pin clamp into the third position.

3. The pin clamp of claim 1, further comprising:
a first angle on a top side of the forward pin clamp portion configured to engage a first latch receiving recess on the rearward pin clamp portion, and a second latch on a bottom side of the forward pin clamp portion configured to engage a second latch receiving recess on the rearward pin clamp portion, wherein the first latch, the second latch, the first latch receiving recess and the second latch receiving recess each have an angled surface to prevent separation of the forward pin clamp portion from the rearward pin clamp portion.

4. The pin clamp of claim 1, wherein the two recesses have a closed end and an open end forward of the closed end, the open end having a dimension larger than the closed end.

5. The pin clamp of claim 1, further comprising a lead-in surface surrounding the opening of the forward pin clamp portion.

6. The pin clamp of claim 1, wherein the two flexible members are offset from each other along a height of the forward pin clamp portion.

7. A bag of parts comprising the pin clamp of claim 1.

8. The pin clamp of claim 1, further comprising a guide pin retaining plate configured for positioning between the forward pin clamp portion and the rearward pin clamp portion.

9. The pin clamp of claim 8, wherein the guide pin retaining plate includes a first holding area for a first guide pin and a second holding area for a second guide pin, the first holding area having a geometry different from the second holding area.

10. A fiber optic connector having removable guide pins, comprising:
at least one housing defining a passageway;
a fiber optic ferrule disposed at least partially within the passageway of the at least one housing of the fiber optic connector, the fiber optic ferrule having guide pin openings extending through the fiber optic ferrule from a front face to a rear face thereof to receive a guide pin therein;
a pin clamp having a forward pin clamp portion to engage the rear face of the fiber optic ferrule, the forward pin clamp portion having guide pin openings therethrough to receive the guide pin and two flexible members extending rearwardly therefrom on opposite lateral sides of an opening of the forward pin clamp portion, and a rearward pin clamp portion positioned rearward of the forward pin clamp portion and configured to engage a spring of the fiber optic connector disposed within the at least one housing and rearwardly of the rearward pin clamp portion of the pin clamp and having two recesses to respectively receive the two flexible members from the forward pin clamp portion and each of the two flexible members is movable between a first position and a second position within each of the two recesses.

11. The fiber optic connector having removable guide pins according to claim 10, further comprising a spring push engaging the spring and the at least one housing to retain the spring and fiber optic ferrule with the at least one housing.

12. The fiber optic connector of claim 10, wherein the forward pin clamp portion and the rearward pin clamp portion are movable relative to one another between a third position in which a guide pin is engaged by the pin clamp and a fourth position in which the guide pin is disengaged from the pin clamp and wherein the spring biases the pin clamp into the third position.

13. The fiber optic connector having removable guide pins according to claim 10, wherein the pin clamp further comprises:
a first latch on a top side of the forward pin clamp portion configured to engage a first latch receiving recess on the rearward pin clamp portion, and a second latch on a bottom side of the forward pin clamp portion configured to engage a second latch receiving recess on the rearward pin clamp portion, wherein the first latch, the second latch, the first latch receiving recess and the second latch receiving recess each have an angled surface to prevent separation of the forward pin clamp portion from the rearward pin clamp portion.

14. The fiber optic connector having removable guide pins according to claim 10, wherein the two recesses have a closed end and an open end forward of the closed end, the open end having a dimension larger than the closed end.

15. The fiber optic connector having removable guide pins according to claim 10, wherein the forward pin clamp portion further comprises a lead-in surface surrounding the opening of the forward pin clamp portion.

16. The fiber optic connector having removable guide pins according to claim 10, wherein the two flexible members are offset from each other along a height of the forward pin clamp portion.

17. The fiber optic connector having removable guide pins according to claim 10, further comprising a guide pin retaining plate configured for positioning between the forward pin clamp portion and the rearward pin clamp portion.

18. The fiber optic connector having removable guide pins according to claim 17, wherein the guide pin retaining plate includes a first holding area for a first guide pin and a second holding area for a second guide pin, the first holding area having a geometry different from the second holding area.

19. The fiber optic connector having removable guide pins according to claim 17, wherein the forward pin clamp portion further comprises at least one forward extending projection to engage a recess in a rear end of the fiber optic ferrule.

20. The fiber optic connector having removable guide pins according to claim 10, wherein the forward pin clamp portion and the rearward pin clamp portion are also movable relative to one another without being separable from one another.
